(19) United States
(12) Patent Application Publication
(10) Pub. No.: US 2007/0066310 A1
(43) Pub. Date: Mar. 22, 2007

(54) Mobile communication terminal and method

(76) Inventors: Rob van der Haar, Helsinki (FI); Juha Hemanus, Helsinki (FI); Akseli Anttila, Helsinki (FI); Valerie Pegon, London (GB)

Correspondence Address: PERMAN & GREEN, 425 POST ROAD, FAIRFIELD, CT, 06824, US

(21) Appl. No.: 11/232,414

(22) Filed: Sep. 21, 2005

(51) Int. Cl. H04Q 7/20

(52) U.S. Cl. 455/445

(57) ABSTRACT

A mobile telecommunications system, and associated methods and mobile communication terminals, is suitable for use by a first user of a first mobile communication terminal and a second user of a second mobile communication terminal, the mobile telecommunications system comprising electronic messaging infrastructure capable of conveying a non-language message, generated in response to an actuation by said first user of an input device included in said first terminal, from said first terminal to said second terminal, such that said non-language message is automatically received and performed in a user interface of the second terminal without manual intervention by said second user.

### FIELD OF THE INVENTION

The present invention generally relates to non-language messaging, for instance for expressing emotions, in mobile telecommunications, and more particularly to methods of and mobile communication terminals for performing non-language messaging in a mobile telecommunications network. The invention also relates to a mobile telecommunications system suited for such methods and terminals.

### BACKGROUND OF THE INVENTION

It is a well known human behavior that people who have close relationships with each other like to maintain frequent emotional contact. The more intimate relation, the more pronounced is probably the desire to keep in touch. Many if not all people of course prefer meeting in real life to maintain such emotional contact. However, practical situations in everyone's life often makes it hard, and sometimes impossible, to meet in real life to the extent desired. Many-people thus have to rely, at least from time to time, on remote communication channels such as voice calls or electronic text messages. Personal computers and mobile communication terminals, such as mobile (cellular) telephones, are of course handy tools in this respect.

Typical emotional maintenance messages are “I love you”, “I miss you” and “I'm thinking of you”. However, even with the use of computers and mobile terminals, many users experience difficulties in finding the time or the right moment for this type of maintenance messaging. Especially between couples with young children there is often little possibility to send such messages. Existing messaging facilities for mobile terminals are limited to “meaningful” and language-based messages like voice or text. Therefore, current messaging facilities require both physical effort (multiple interactions between user and terminal, e.g. typing a text message by a series of key depressions on a keypad) and mental effort (thinking of what to say or type, and then constructing the message) by a user who wants to send such a message. In addition, manual intervention is required also by a user that receives such a message; the receiving user will first receive a notification (e.g. a new call or a new text message), that he or she needs to accept in order to take the call or open the message. Then, the receiving user will have to listen to the call or read the text message and mentally interpret it. In summary, current language-based messaging with mobile communication terminals requires multiple intervention both by sender and by receiver.

### SUMMARY OF THE INVENTION

In view of the above, an objective of the invention is to solve or at least reduce the problems discussed above. More specifically, the invention aims at providing non-language messaging in a mobile telecommunications network using mobile communication terminals in a highly automated manner which is particularly well suited for impulsive exchange of emotions between users of mobile communication terminals.

Generally, this is achieved by methods of and mobile communication terminals for performing non-language messaging in a mobile telecommunications network, and a mobile telecommunications system, according to the attached independent patent claims.

Briefly speaking, one embodiment of the present invention provides one-button direct access for a user of a mobile terminal to send a signal (for instance using an existing carrier technology such as SMS) to another (predefined) mobile terminal, the signal representing a non-language message. The signal will result in a direct visual, auditory or tactile effect upon reception at the receiving mobile terminal. The effect can be temporary, long lasting or degrading over time, and no action is required by the receiving user. The effect can be reinforced or enhanced by multiple key presses at the sending terminal, or by multiple senders sending a respective signal to the same receiver within a short time frame. The receiver will be able to reply to the signal either in a similar fashion as described above or by a normal voice call or text message. By default, the signal will not contain a “meaningful” (i.e., verbal, language-based) message; meaning rather comes from shared context or shared history of the parties involved in the communication. Users could choose to use for instance a sound, vibration, icon, color, or perhaps a short piece of text like a word or two having a special meaning between the parties.

This has several benefits:

Little mental or physical effort required from both sender and receiver.

An easy way to feel connected with others.

Supports the need for emotional maintenance messaging.

Can be used in almost all situations.

Potential revenue generator for operators of mobile telecommunication networks.

A first aspect of the invention is a method of performing non-language messaging in a mobile telecommunications network for mobile communication terminals, the method involving:

detecting, in a first mobile communication terminal, a first user's actuation of an input device included in said first terminal;

determining a second user having an association with the detected first user's actuation;

obtaining a non-language message; and

transmitting the non-language message onto the mobile telecommunications network in a signal intended for said second user at a second mobile communication terminal, wherein the signal is adapted for automatic reception and performance of the non-language message in a user interface of the second terminal without manual intervention by said second user.

Said step of detecting a first user's actuation of an input device may involve detecting depression of a particular key among a plurality of keys, such as a long-press of an alphanumeric key on a keypad, or actuation of a soft key, i.e. a key that has a context-dependent function which is indicated on a display of said first mobile communication terminal. Alternatively, this step may involve detecting depression of a first key, such as an alphanumeric key, followed by depression of a second key, such as a dedicated key for non-language messaging, among a plurality of keys. In this respect, a “key” embraces, but is not limited to, a mechanical key which is physically depressible and the actuation of which is detected e.g. by the closing of an electric contact or circuit, or a touch-sensitive key the actuation of which is detected by e.g. piezoelectric, capacitive, optical or magnetic means. Therefore, a “depression” of a key is not limited to a case where actuation of the key causes physical movement thereof.

Advantageously, said steps of determining a second user, obtaining a non-language message and transmitting the non-language message are performed without manual intervention by said first user.

Predefined data may be provided which is stored in local memory in said first mobile communication terminal and which associates different types of actuation of said input device with different users of mobile communication terminals, wherein said step of determining a second user may be performed by searching said predefined data in said local memory and finding said second user as a matching association with the detected first user's actuation.

Such predefined data may also define, for a specific type of actuation and associated mobile terminal user, a specific non-language message, wherein said step of obtaining a non-language message may be performed by deriving said non-language message from said predefined data for which said second user has been found as a matching association with the detected first user's actuation.

In one embodiment, said step of obtaining a non-language message involves:

presenting a set of non-language message candidates on a display of said first mobile communication terminal;

detecting a manual selection by said first user of one message candidate in said set; and

using the selected message candidate as the non-language message to be transmitted in said signal intended for said second user.

The automatic performance of the non-language message advantageously involves generating a direct effect in the user interface of the second terminal, said direct effect including at least one effect selected from the group consisting of: a visual effect, an auditory effect and a tactile effect.

The direct effect may involve displaying an icon, still image, graphical animation or video sequence on the display of the second terminal, or changing or modifying a general color tone in the user interface (such as a color of the display background, or of certain user interface elements). Additionally or alternatively, the direct effect may involve playing a sound effect or a music sequence through a loudspeaker of the second terminal, and/or generating a buzz pattern by means of a vibrator in the second terminal.

Said step of transmitting the non-language message onto the mobile telecommunications network in a signal intended for said second user may involve incorporating the non-language message in an electronic message conveyed by electronic messaging infrastructure in the mobile telecommunications network. The electronic message conveyed by such electronic messaging infrastructure in the mobile telecommunications network may be selected from the group consisting of: Short Message Services (SMS), Multimedia Message Services (MMS) and email. In one embodiment, each non-language message is transported in the payload (message) section of an SMS message.

A second aspect of the invention is a method of performing non-language messaging in a mobile telecommunications network for mobile communication terminals, the method involving:

receiving, in a second mobile communication terminal having a second user, a signal originating from a first user of a first mobile communication terminal;

deriving from said signal a non-language message intended for said second user; and

performing the non-language message in a user interface of the second terminal;

wherein no manual intervention is required from said second user in said steps of receiving, deriving and performing.

Advantageously, said step of performing the non-language message involves generating a direct effect in the user interface of the second terminal, said direct effect including at least one effect selected from the group consisting of: a visual effect, an auditory effect and a tactile effect.

Said steps of receiving a signal and deriving a non-language message may involve receiving an electronic message conveyed by electronic messaging infrastructure in the mobile telecommunications network, and obtaining said non-language message from a payload of said electronic message. In one embodiment, the electronic message conveyed by electronic messaging infrastructure in the mobile telecommunications network is selected from the group consisting of: Short Message Services (SMS), Multimedia Message Services (MMS) and email.

One embodiment of the second aspect comprises the steps of

receiving an additional signal;

deriving from said additional signal an additional non-language message intended for said second user; and

if said additional non-language message fulfills a prerequisite, generating an enhanced version of said direct effect in the user interface of the second terminal. Such prerequisite may be at least one of the following:

that said additional signal originates from said first user;

that said signal and said additional signal are received within a certain time period;

that said non-language message and said additional non-language message are of a same type or of associated types.

In one embodiment, the direct effect generated in the user interface of the second terminal is temporary and ends after a certain time. The direct effect generated in the user interface of the second terminal may be degraded before it ends after said certain time.

One embodiment of the second aspect involves the further step, upon performing said non-language message, of:

providing an offer in the user interface of the second terminal for said second user to establish communication with said first user over said mobile telecommunications network.

After acceptance of said offer has been given by said second user, communication may be established with said first user by one of the following communication channels: an electronic message, a non-language message, a voice call or a video call.

A third aspect of the invention is a mobile communication terminal having a wireless interface to a mobile telecommunications network and a user interface capable of performing the steps of the method according to the first aspect.

A fourth aspect of the invention is a mobile communication terminal having a wireless interface to a mobile telecommunications network and a user interface capable of performing the steps of the method according to the second aspect.

A fifth aspect of the invention is a mobile telecommunications system suited for a first user of a first mobile communication terminal and a second user of a second mobile communication terminal, the mobile telecommunications system comprising electronic messaging infrastructure capable of conveying a non-language message, generated in response to an actuation by said first user of an input device included in said first terminal, from said first terminal to said second terminal, such that said non-language message is automatically received and performed in a user interface of the second terminal without manual intervention by said second user.

Other objectives, features and advantages of the present invention will appear from the following detailed disclosure, from the attached dependent claims as well as from the drawings.

### BRIEF DESCRIPTION OF THE DRAWINGS

Embodiments of the present invention will now be described in more detail, reference being made to the enclosed drawings.

FIG. 1 is a schematic illustration of a telecommunication system, including-mobile communication-terminals and a mobile telecommunications network, as an example of an environment in which the present invention may be applied.

FIG. 2 schematically illustrates the principle behind the present invention for direct non-language messaging from a first mobile communication terminal to a second one with automatic receipt and performance of the non-language message at the latter.

FIG. 3 illustrates an exemplifying chain of display screen snapshots from first and second mobile communication terminals when performing direct non-language messaging.

FIG. 4 is a block diagram illustrating a mobile communication terminal according to one embodiment in more detail.

### DETAILED DESCRIPTION OF THE INVENTION

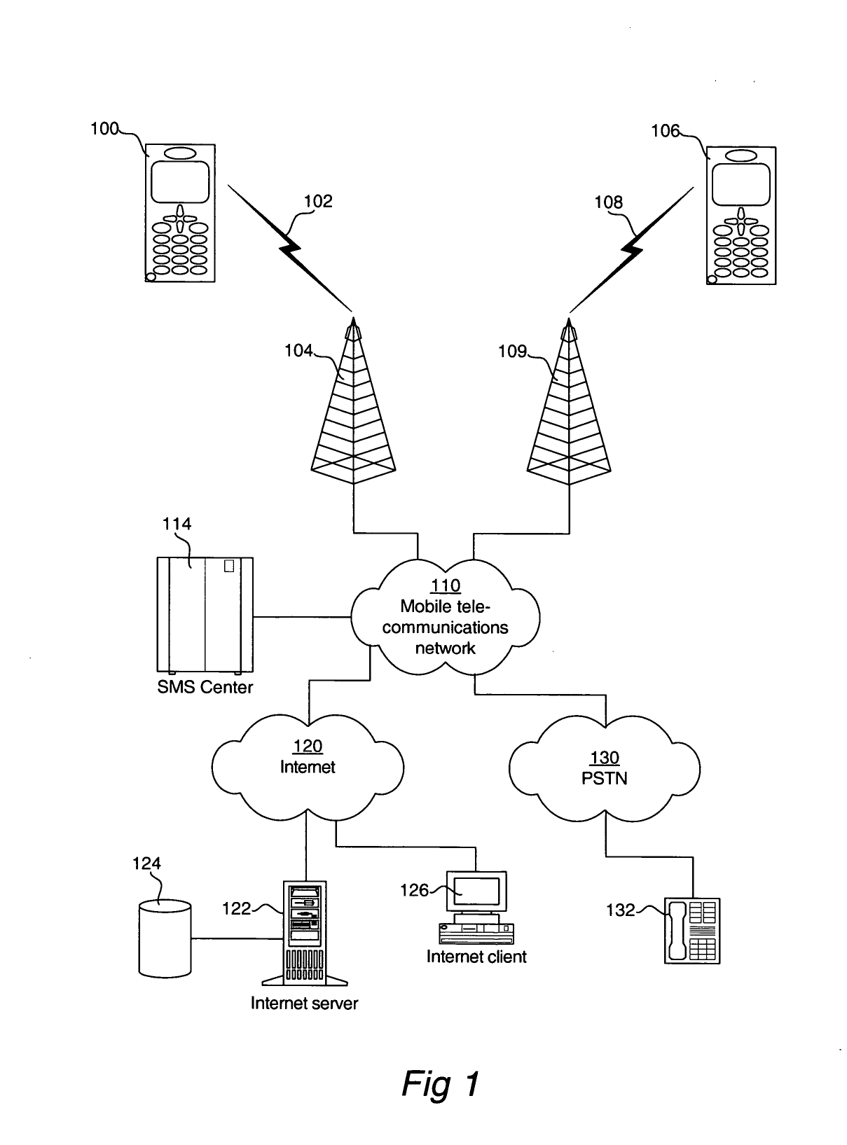

First, with reference to FIG. 1, one example of a telecommunication system in which the invention may be applied will be briefly described. Then, with reference to the remaining drawings, embodiments of the invention will be described in more detail.

In the telecommunication system of FIG. 1, various telecommunications services such as voice calls, data calls, facsimile transmissions, music transmissions, still image transmissions, video transmissions, electronic message transmissions and electronic commerce may be performed between different mobile communication terminals 100, 106. Among these services, electronic message transmissions are of particular importance for the present invention. In the following, SMS (Short Messaging Services) messages are used an one example of such electronic message transmissions, but other types of messages, including but not limited to MMS (Multimedia Messaging Services) or email messages, are also included in this concept.

The mobile terminals 100, 106 are connected to a mobile telecommunications network 110 through RF links 102 and 108 via respective base stations 104, 109. The mobile telecommunications network 110 may be any commercially available mobile telecommunications system, such as GSM, UMTS, D-AMPS or CDMA2000. The mobile terminals 100, 106 are illustrated as mobile (cellular) telephones but may alternatively be other kinds of portable devices, such as portable digital assistants (PDAs) or communicators.

A public switched telephone network (PSTN) 130 is connected to the mobile telecommunications network 110 in a familiar manner. Various telephone terminals 132 are connected to the PSTN 130.

The mobile telecommunications network 110 is operatively connected to a wide area network 120, which may be Internet or a part thereof. An Internet server computer 122 has a data storage 124 and is connected to the wide area network 120, as is an Internet client computer 126.

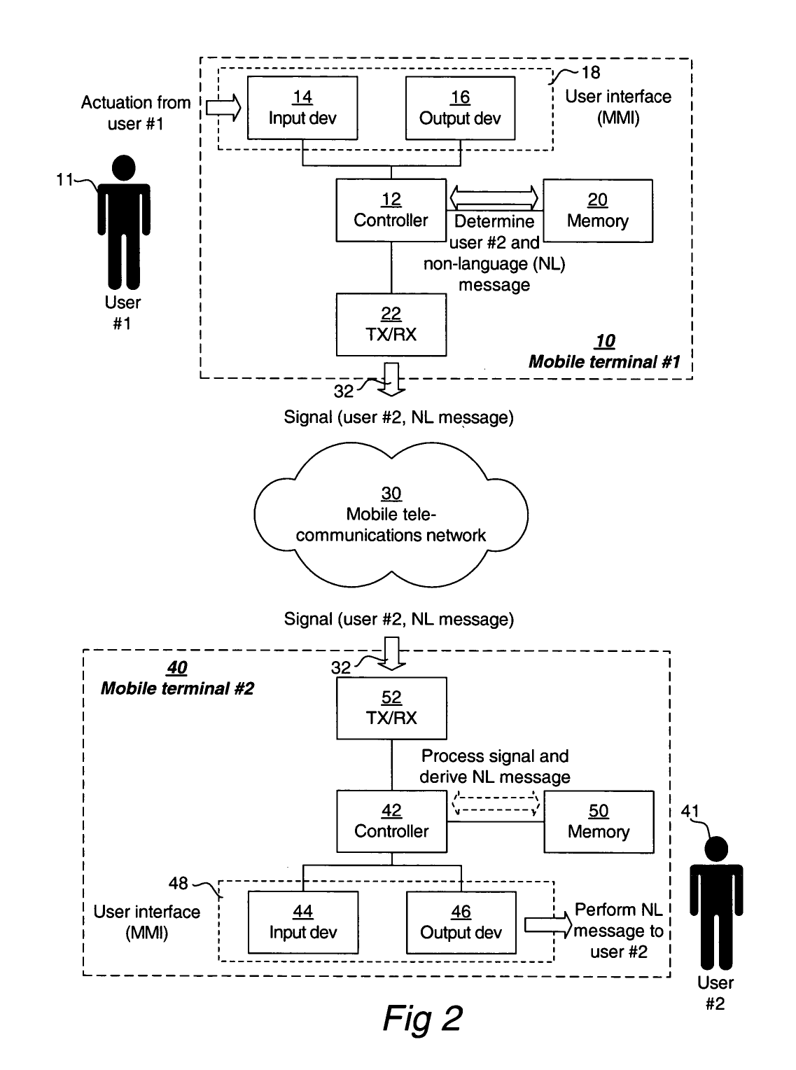

The mobile telecommunications network 110 has an SMS center 114 in a well known manner. Users of the mobile terminals 100, 106 may receive SMS messages from the SMS center 114 over the radio links 102, 108 and, of course, also send outgoing SMS messages to the SMS center 114. These SMS messages may be ordinary, language-based messages that convey a text, which has been manually entered by a user at one terminal 100, to another terminal 106 to be opened and read by another user. Apart from this, however, the SMS messaging infrastructure of the mobile telecommunications network is used in a novel way in one embodiment for carrying non-language messages between users of mobile terminals. This will be explained in more detail with reference to FIG. 2.

FIG. 2 illustrates communication of non-language messages between a first user 11 of a first mobile communications terminal 10 (which may be terminal 100 of FIG. 1) and a second user 41 of a second mobile communications terminal 40 (which may be terminal 106 of FIG. 1) over a mobile telecommunications network 30 (which may be network 110 of FIG. 1), in accordance with the concept of the present invention. Each mobile terminal 10/40 comprises a controller 12/42, a local memory 20/50, a transmitter/receiver 22/52 for accessing the mobile telecommunications network 30, and a user interface 18/48 including an input device 14/44 and an output device 16/46. The input device 14/44 includes a set of keys which may include a keypad of common ITU-T type (alphanumerical keypad representing characters “0”-1“9”, “*” and “#”) as well as other keys such as soft keys and/or call handling keys. Other input means such as a four/five way navigation key and/or a joystick may also be included in the input device 14/44. The output device 16/46 may include a display, one or more LEDs, a loudspeaker (earphone) and a vibrator (buzzer).

To send a direct non-language (NL) message to the second user 41, the first user 11 simply actuates the input device 14 in a predefined manner. For instance, user 11 may select a soft key or perform a long-press on an alphanumeric key. In the local memory 20 there is stored a predefined association between the actuation in question (i.e., the selected soft key or long-pressed alphanumeric key) and an intended receiver—who in this example is the second user 41. This predefined association will have been made some time in the past by the first user 11, as will be described in more detail later. Thus, upon detecting the first user's actuation of the input device 14, the controller 12 in the first terminal 10 will determine the intended NL message receiver (second user 41) by referring to the predefined association in memory 20. The controller 12 will also obtain a predefined NL message that is to be sent to the second user 41. Again, the predefined NL message will have been created or otherwise defined some time in the past by the first user 11, who then also associates the NL message with its intended receiver, i.e. the second user 41. In one embodiment, only one predefined NL message may be associated with an intended receiver for a particular input device actuation, and in such a case, the controller will automatically determine not only the second user 41 as the intended receiver, but also the NL message that is to be sent, by referring to the memory 20. In another embodiment, several NL messages may be given a predefined association with the intended receiver. In such a case, after having determined the second user 41 as the intended receiver, the controller 12 may determine all NL messages that are associated with the second user and present them as candidates in a selection list on the display. The first user 11 may then select, by way of the input device 14, which NL message candidate he or she would like to send to the intended receiver.

In one embodiment, the input device includes a plurality of alphanumeric keys as well as a dedicated key for non-language messaging. Simply selecting the dedicated key without prior actuation of any of the alphanumeric keys will bring about a menu of available options relating to non-language messaging, such as “Create new message”, “Add receiver”, “Send to receiver”, etc. However, if an alphanumeric key is first selected, a non-language message will be sent to a predefined receiver associated with the selected alphanumeric key upon subsequent actuation of the dedicated key.

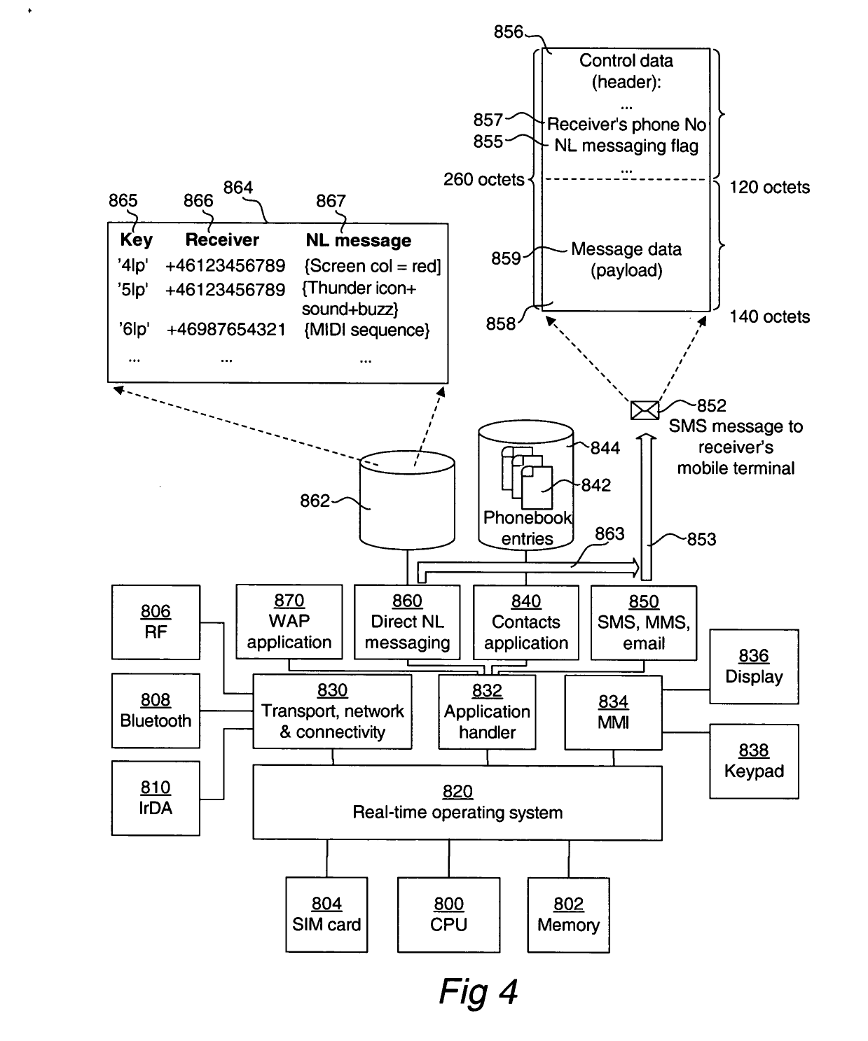

Once the controller 12 has determined the intended receiver, in the form of the second user 41, and the NL message he or she shall receive, the controller 12 controls the transmitter/receiver 22 to transmit onto the mobile telecommunications network 30 a signal 32 containing the NL message and intended for receipt by the second terminal 40 and second user 41. In the disclosed embodiment, the signal 32 is an SMS message which is conveyed by the SMS messaging infrastructure (e.g. SMS center 114 of FIG. 1) in the mobile telecommunications network 30 from the first terminal 10 to the second terminal 40. As will be explained in more detail with reference to FIG. 4, the NL message is represented in the payload section of such an SMS message.

The signal 32, e.g. the SMS message with its payload containing the NL message, is received by the transmitter/receiver 52 of the second mobile communications terminal 40. The controller 42 thereof processes the received signal, e.g. opens the SMS message and derives the NL message represented therein from the SMS message payload. The thus derived NL message is then performed automatically by the controller 42 in the user interface 48 by generating a direct visual, auditory or tactile effect with the output device 46, without requiring any manual intervention from the second user 41. Optionally, the controller 42 may provide an offer in the user interface of the second terminal for the second user 41 to establish communication with the first user 11 over the mobile telecommunications network 30, i.e. to reply to the received NL message. The offer may for instance be given by presenting a dialog on the display or assigning a reply function to a soft key. Such a reply may either be a true response in the form of an NL message which is sent back to the first user 11 and causes an automatic visual, auditory or tactile effect in the user interface 18 without intervention from the first user 11, or another kind of response, such as an ordinary language-based electronic message (e.g. SMS, MMS or email) or voice call/video call.

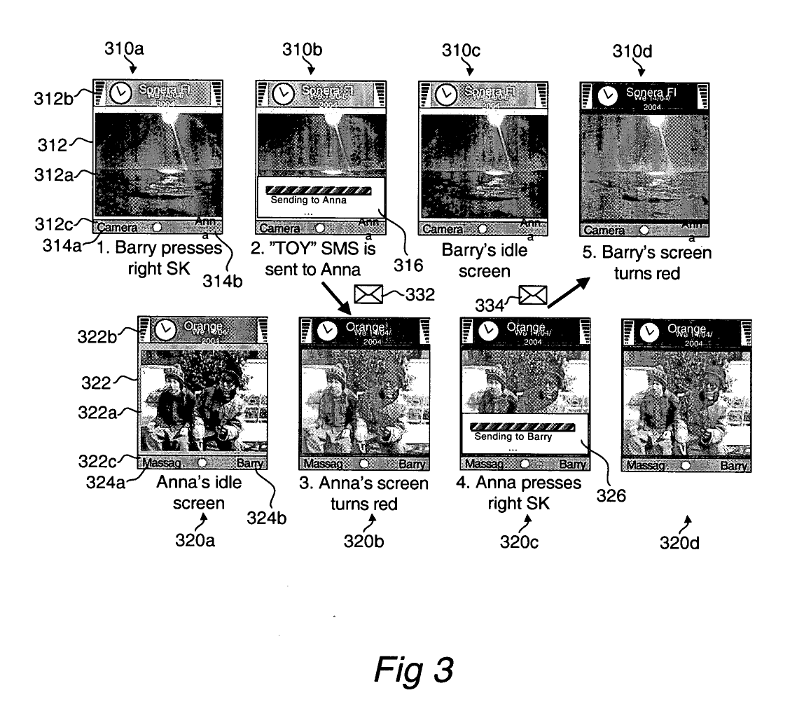

FIG. 3 illustrates an exemplifying chain of display screen snapshots 310a-d and 320a-d from a first user's (“Barry”) terminal and a second user's (“Anna”) terminal, respectively, when two NL messages are communicated as SMS messages 332 and 334 from Barry to Anna and, in response, from Anna to Berry. In more detail, as seen at 310a and 320a, both Barry's display 312 and Anna's display 322 have a disposition which is typical in the technical field; it comprises a main display area 312a/322a, an upper status indicator panel 312b/322b and a lower soft-key panel 312c/322c. In the idle screen state shown at 310a and 320a Barry's display 312 has an arbitrary default color, and so has Anna's display 322. The soft-key panels 312c and 322c display labels 314a-b and 324a-b for two soft keys included in the input device of Barry's terminal and Anna's terminal, respectively. More particularly, Barry's right soft key (SK) 314b has been predefined by him to represent Anna as an intended receiver of a particular NL message, namely one that expresses a “Thinking Of You” (TOY) emotion. More precisely, the TOY NL message is defined to turn the background color of Anna's mobile terminal into red.

Thus, upon Barry's actuation of the right soft key 314b, his terminal will automatically refer to this predefined relationship, as has been described above, and generate an SMS message 332 to Anna, including the TOY NL message. A progress bar 316 informs Barry of this, as seen at 310b. Barry's display 312 then resumes its idle state, as seen at 310c.

Upon reception of the SMS message 332, Anna's terminal will automatically process the contents thereof, i.e. the TOY NL message, in the manner explained above and cause the color of Anna's display 322 to turn from the default color at 320a to red as seen at 320b, in accordance with the meaning of the TOY NL message. Thus, without any manual intervention from Anna, Barry's desire to express his Thinking Of You emotion to Anna will be perceived by her with only a simple glance at her display 322.

At 320c, Anna decides to send a TOY NL message in return to Barry and therefore presses her right soft key 324b. This soft key may either have been predefined in advance by Anna, like Barry did with his, to represent a TOY NL message intended for Barry, or alternatively, Anna's terminal may be adapted to automatically change the meaning of this soft key from something else into “reply to sender (Barry) by sending an NL message of the same type (TOY)”, upon receipt of the first TOY NL message from Barry. The thus invoked TOY NL message is sent to Barry in a second SMS message 334. A progress bar 326 is presented on Anna's display 322, which may retain its changed color for still some time, as seen at 320d, possibly with some predefined degradation effect until it eventually resumes its default background color.

When receiving the second SMS message 334, Barry's terminal will process the TOY NL message represented therein and turn the display background color of Barry's display 312 into red, thereby conveying Anna's TOY emotion to him without requiring any manual intervention (other than, of course, looking at the display).

Reference is now made to FIG. 4, which illustrates a mobile communication terminal according to one embodiment in more detail, with particular focus on direct NL messaging. The mobile communication terminal of FIG. 4 may be any one of the terminals 100, 106, 10 and 40 of FIGS. 1 and 2.

As seen in FIG. 4, a controller 800 is responsible for the overall operation of the mobile terminal and is preferably implemented by any commercially available CPU (“Central Processing Unit”), DSP (“Digital Signal Processor”) or any other electronic programmable logic device. The controller 800 has associated electronic memory 802 such as RAM memory, ROM memory, EEPROM memory, flash memory, or any combination thereof. The memory 802 is used for various purposes by the controller 800, one of them being for storing data and program instructions for various software in the mobile terminal. The software includes a real-time operating system 820, a man-machine interface (MMI) module 834, an application handler 832 as well as various applications. In the illustrated example, the applications include a contacts (phonebook) application 840, a conventional (language-based) messaging application 850 (e.g. for SMS, MMS and email) and a WAP (Wireless Application Protocol) application 870. The MMI module 834 includes drivers that cooperate with various MMI or input/output (I/O) devices, including a display 836 and a keypad 838. Various other I/O devices, such as a microphone, a speaker, a vibrator, a joystick, a ringtone generator, an LED indicator, etc, may cooperate with the MMI module 834. The MMI module 834 also contains software for providing a graphical user interface (GUI) to a user of the mobile terminal. Therefore, as is commonly known per se, the user may operate the mobile terminal through the man-machine interface thus formed.

The software in the mobile terminal also includes various modules, protocol stacks, drivers, etc., which are commonly designated as 830 and which provide communication services (such as transport, network and connectivity) for an RF interface 806, and optionally a Bluetooth interface 808 and an IrDA interface 810. The RF interface 806 comprises an internal or external antenna as well as appropriate radio circuitry for establishing and maintaining a wireless link to a base station (e.g. the link 102/108 and base station 104/109 in FIG. 1). As is well known to a man skilled in the art, the radio circuitry comprises a series of analogue and digital electronic components, together forming a radio receiver and transmitter. These components include, inter alia, band pass filters, amplifiers, mixers, local oscillators, low pass filters, AD/DA converters, etc.

The mobile terminal also has a SIM card 804 and an associated reader. As is commonly known, the SIM card 804 comprises a processor as well as local work and data memory.

The contacts application 840 handles a plurality of contact entries or records 842, which are stored in a data storage 844 which may be physically accommodated in the memory 802. Each contact entry 842 has data fields with information on the represented person's name and mobile phone number, plus preferably other information such as other phone numbers, postal address, email address, VAD (Voice-Activated Dialling) data, etc.

The language-based messaging application 850 provides conventional messaging services such as SMS, MMS and email. The user of the mobile terminal may thus generate for instance a text-based SMS message by inputting the desired text through the keypad 838, designate an intended receiver by e.g. referring to one of the contact entries 842 of the contacts application 840, and have the text-based SMS message sent via modules 830 and 806 over the mobile communications network and the messaging infrastructure therein (e.g. network 110 and SMS center 114 of FIG. 1), so as to ultimately arrive at the intended receiver's mobile terminal.

In addition to this, a non-language messaging application 860 is provided in the mobile terminal of FIG. 4. This NL messaging application 860 provides the NL messaging services which have already been described above and thus allows the mobile terminal user to send impulsive, direct NL messages to an intended receiver at another mobile terminal, expressing for instance a certain emotion to that user without any need for manual intervention from the latter. The NL messaging application 860 has a data storage 862 which may be physically accommodated in the memory 802. In the data storage 862, data 864 is stored which associates different actuations 865 of the mobile terminal's input device, e.g. keyboard 838, with different predefined NL messages 867 and different intented receivers 866 thereof.

As seen in FIG. 4, the data 864 for instance specifies that upon long-press actuation (‘lp’) of alphanumeric key ‘4’, an NL message is to be sent to a receiver having mobile phone No ‘+46123456789’, causing an automatic effect of turning this receiver's display screen color into red, like in the example given above for FIG. 3. If instead a long-press on key ‘5’ is done, the same receiver is to be presented with a thunder icon combined with an appropriate thunder sound effect and synchronized vibration pattern via the receiver's buzzer, thereby expressing a “bad & angry mood”. Doing a long-press on key ‘6’ will generate an NL message to another receiver, ‘+46987654321’, and cause automatic playback of a music sequence or sound effect upon reception at that receiver's mobile terminal. In one embodiment, the data 864 may also contain a short explanatory text label for each associated NL message, to be shown in a progress bar on the sender's display as a confirmation to him or her that an NL message of the type explained by the label is being sent to the intended receiver. For instance, instead of just “Sending to Anna . . . ”, the progress bar 316 of FIG. 3 could read “Sending TOY to Anna . . . ”.

The NL messaging application 860 has functionality which allows the user of the mobile terminal to update the data 864 in the data storage 862, such as adding new types of non-language messages or editing or deleting existing ones. To this end, the NL messaging application 860 may have some editor functionality that allows the user to e.g. create a graphical icon, compose a sound effect or a music sequence (monophonic or polyphonic/MIDI), design a vibration pattern, etc, and save this as a predefined NL message type. It is also conceivable that the user may retrieve contents from other sources within the mobile terminal, or even from a remote data storage such as data storage 124 of Internet server 122 in FIG. 1, when defining such new types of NL messages. Moreover, the NL messaging application 860 may contain a default set of prestored NL message types that are included from manufacturer or network operator.

The user may also update the data 864 in the data storage 862 to create, edit or delete among the aforedescribed associations between different input device actuations 865, NL messages 867 and intended receivers 866. When specifying a certain intended receiver, the user may refer to one of the contact entries 842 of the contacts application 840, or specify the receiver's mobile phone number by manual input.

In one embodiment, the functionality of the NL messaging application 860 may be integrated in the contacts application 840, such that a contact entry 842 will include data that specifies a certain NL message to be transmitted to the person represented by the contact entry in question upon a certain input device actuation. In another embodiment, the functionality of the NL messaging application 860 may be integrated in another existing application, such as a call handling application. In still another embodiment, a single messaging application may handle both ordinary language-based messages, like text-based SMS, MMS or email, and well as NL messaging functionality.

In the embodiment disclosed in FIG. 4, an NL message generated in the NL messaging application 860 is transported as payload in an SMS message 852, which is sent via the SMS messaging infrastructure in the mobile communications network to the receiver's mobile terminal. To this end, as indicated at 863, the NL messaging application 860 invokes the language-based messaging application 850 and makes use of its already existing interface 853 for SMS communication. The composition of a typical outgoing SMS message 852 is illustrated in FIG. 4. The SMS message 852 has a control data portion 856 and a message data portion 858. The control data portion 856 occupies 120 octets. The message data portion 858 occupies 140 octets and contains the payload of the SMS message, i.e. the actual message data 859. The entire message data portion 858 does not always have to be filled with valid data; in case the message does not occupy all of the message data portion 858, some part thereof may contain garbage data. Alternatively, the message data portion 858 may be terminated after the last valid octet by a predetermined control character, or the length of the message data portion 858 may be indicated as a header parameter in the control data portion 856.

The control data portion 856 contains various protocol layer-specific and message type-specific control data, including a specification of the phone number 857 of the intended receiver. For details about the format of SMS messages, reference is made to available standards for 2G, 2.5G and 3G mobile telecommunications systems. For instance, the SMS service for 3G systems is decribed in detail in “3GPP TS 24.011”, which is available at http://www.3gpp.org/.

To differentiate between a case where the SMS message 852 is an ordinary language-based message (containing meaningful text in the message payload 859) and a case where the payload 859 represents an NL message, an NL messaging flag 855 may be provided in the message header 856. As is well known per se, a conventional text SMS represents the message text as 160 7-bit characters (maximum) in the message payload 859, whereas an NL message may conveniently be represented as 140 8-bit octets of binary data in the message payload 859. To allow further differentiation between an NL message payload and other kinds of binary-data SMS (such as auto-configuration SMS which is used in some existing mobile telecommunications systems), the leading octet(s) of the payload may contain unique control character(s) that unambiguously indicates to the receiving mobile terminal that the SMS message 852 in question indeed has an NL message represented in its payload.

The receiving mobile terminal will also be provided with an instance of the NL messaging application 860, or have the functionality thereof implemented in some other way. Upon reception, the receiving mobile terminal will automatically process the incoming SMS message 852, analyze it as described above to differentiate it from an ordinary text-based SMS, then derive the NL message from the SMS message payload and perform the effect specified therein in cooperation with the user interface elements of that terminal.

Referring back to the general discussion in conjunction with FIG. 2, depending on implementation and/or particulars such as size and format of the NL message, it may be included in its entirety as digital data (e.g. binary data that encodes a small graphical icon or a music sequence) in the payload of the signal 32, or it may be transferred only in the form of a link or reference to the actual data that constitutes the message. In the latter case, a reference table may be stored in local memory of the receiving terminal (e.g. the second mobile terminal 40 of FIG. 2), to be used when receiving an NL message by this terminal for interpreting the meaning of such an included link or reference. For instance, such a reference table may define a plurality of predefined non-language effects, and the actual NL message only needs to contain a reference to the particular desired effect, as is shown in the following example:

| Reference | Effect to be caused in user interface upon |
|---|---|
| code | receipt of NL message |
| ‘001’ | Turn display red, degrade = OFF |
| ‘002’ | Turn display red, degrade = ON |
| . . . | . . . |
| ‘101’ | Show predefined “heart” icon |
| ‘102’ | Show predefined “smiley” icon |
| . . . | . . . |
| ‘201’ | Play MIDI tune 01 |
| ‘202’ | Play MIDI tune 02 |
| . . . | . . . |
| ‘301’ | Activate buzzer, 3 seconds |
| ‘302’ | Activate buzzer intermittently |
| . . . | . . . |

In the above example, the sending terminal only have to transmit a reference code ‘002’ in the payload of the signal 32 to cause the display of the receiving terminal to turn red, with a degrading effect over time. It is possible for an NL message to be constituted by more than one reference code, for instance “101202” that in the example above would specify “Show heart icon and play tune 02”.

As an alternative, references may point at contents stored remotely, for instance in the data storage 124 of the Internet server 122 of FIG. 1. When such a reference is detected in a received NL message by a receiving terminal, this terminal may access the remote data source to download the contents referred to in the reference, and then perform the contents locally in the receiving terminal so as to cause the NL effect intended by the sending user.

In an alternative embodiment, more advanced references are used when conveying an NL message from a sending terminal to a receiving terminal. These advanced references are similar to function calls and allow arguments, e.g. “Change_bg_color(color_code, duration, degradation_flag)”.

For instance, by transmitting “Change_bg_color (01,4,1)” in an NL message, the sender may command changing the display background color of the receiving terminal to red (color code 01) for a total of 4 seconds with a degrading effect (flag=1), so that the display background color changes from the existing color to red, then starts to reduce in intensity, or gradually return to the former color, after say 2 seconds, so that the display background color has returned to the former color after 4 seconds.

It is possible, within the concept of the present invention, to allow message cascading in a way that will now be described. If a mobile terminal, such as the second terminal 41 of FIG. 2, after having received a first signal with a first NL message in the way described above, then receives an additional signal with a second NL message within a certain time period, the NL messaging functionality may be adapted to enhance the direct effect caused at receipt of the first signal.

Prerequisites may be applied in this respect, such that the direct effect enhancement is only performed if the second signal is received from the same sender as the first signal, and/or if the first and second NL messages are of the same type or of associated types. Another prerequisite may be that direct effect enhancement is only performed if the second signal is received before the direct effect caused by the first signal has ceased in the receiving terminal.

Here follows some examples of direct effect enhancements in response to receiving cascaded NL messages:

1: Send a heart symbol to girlfriend or boyfriend. Sending this NL message multiple times in a short time period will cause presentation of multiple hearts in various sizes that bubble over girlfriend's or boyfriend's display.

2: Send an animation of a kissing mouth with a kissing sound being played to girl friend or boy friend. Multiple key presses results in multiple kisses, possibly also a bit more raunchy with perhaps French kissing.

3: Send a sound clip of a revving engine to a friend with a picture of the favorite road to indicate that it is time to roll. Multiple key presses results in the engine being revved even further and tread marks being drawn on the friend's display, his phone starting to vibrate in sync with the revving.

4: Send a TOY NL message as illustrated in FIG. 3, with effect degradation after some time. If an additional TOY NL message is sent after effect degradation has begun but before it has been completed, the receipt of the additional message will cause an interruption, delay or even reversal of the effect degradation.

Since the proposed direct non-language messaging will allow mobile communication terminals to affect each other's user interfaces without manual user intervention at the receiver side, some approval scheme may advantageously be set up. Therefore, in one embodiment, the NL messaging application 860 (or similar direct NL functionality) is adapted, when a user first assigns a receiver to a certain key, to send a message to the proposed receiver asking if he/she will accept any NL messages from that sender. Only if appropriate confirmation is received from the proposed receiver will he or she be stored as receiver in the data 864 that associates key presses with receivers and NL messages. Alternatively, the receiving side may have a block list that prevents NL messages from certain users from having a direct effect of the user interface, or an approved list containing senders from which NL messages are allowed to be received and automatically performed. Still other security measures are of course possible so as to prevent abuse of the NL messaging service.

In the embodiments described above, intended NL message receivers are predefined and associated with respective input device actuations on beforehand. In an alternative embodiment, only the NL message is associated with a certain input device actuation on beforehand, and the intended receiver is selected in a dialog box, etc, only upon actuation of the input device (i.e., at the time when the user commands sending of an NL message).

Even if SMS has been used above in the disclosed embodiments as carrier medium for NL messages according to the invention, other carrier media are also possible, such as MMS or email. In the latter case, each terminal may be provided with an email client capable of receiving emails according to the POP3 or IMAP4 protocol and sending emails according to the SMTP protocol. These protocols allow user-defined (i.e., non-mandatory) fields in the header section. As is well known per se, such a user-defined field begins with an “X”, like in “X-my_header_field”. This may be conveniently used to indicate that a current email carries an NL message in its payload section. As still an alternative, the NL messaging service of the present invention may be performed not by using existing electronic messaging infrastructure in the mobile telecommunications network, but instead dedicated messaging protocols, channels and equipment which are designed exclusively for conveying signals representing NL messages between mobile communication terminals. Still one alternative is to use WAP push technology (e.g. by using WAP application 870 of FIG. 4) for conveying the NL messages.

The description above has referred to use cases where the sender sends an NL message to a single receiver. However, the invention may just as well be applied to a case where the sender chooses a group of receivers and sends the NL message to all members of this group at the same time.

The invention has mainly been described above with reference to a number of embodiments. However, as is readily appreciated by a person skilled in the art, other embodiments than the ones disclosed above are equally possible within the scope of the invention, as defined by the appended patent claims.

1. A method of performing non-language messaging in a mobile telecommunications network for mobile communication terminals, the method involving:
detecting, in a first mobile communication terminal, a first user's actuation of an input device included in said first terminal;
determining a second user having an association with the detected first user's actuation;
obtaining a non-language message; and
transmitting the non-language message onto the mobile telecommunications network in a signal intended for said second user at a second mobile communication terminal, wherein the signal is adapted for automatic reception and performance of the non-language message in a user interface of the second terminal without manual intervention by said second user.

2. The method as defined in claim 1, wherein said step of detecting a first user's actuation of an input device involves detecting depression of a particular key among a plurality of keys.

3. The method as defined in claim 2, wherein the depression of a particular key is a long-press of an alphanumeric key on a keypad.

4. The method as defined in claim 2, wherein said particular key is a soft key, i.e. a key that has a context-dependent function which is indicated on a display of said first mobile communication terminal.

5. The method as defined in claim 1, wherein said steps of determining a second user, obtaining a non-language message and transmitting the non-language message are performed without manual intervention by said first user.

6. The method as defined in claim 1, involving a step of providing predefined data which is stored in local memory in said first mobile communication terminal and which associates different types of actuation of said input device with different users of mobile communication terminals, wherein said step of determining a second user is performed by searching said predefined data in said local memory and finding said second user as a matching association with the detected first user's actuation.

7. The method as defined in claim 6, said predefined data also defining, for a specific type of actuation and associated mobile terminal user, a specific non-language message, wherein said step of obtaining a non-language message is performed by deriving said non-language message from said predefined data for which said second user has been found as a matching association with the detected first user's actuation.

8. The method as defined in claim 1, wherein said step of obtaining a non-language message involves:
presenting a set of non-language message candidates on a display of said first mobile communication terminal;
detecting a manual selection by said first user of one message candidate in said set; and
using the selected message candidate as the non-language message to be transmitted in said signal intended for said second user.

9. The method as defined in claim 1, wherein the automatic performance of the non-language message involves generating a direct effect in the user interface of the second terminal, said direct effect including at least one effect selected from the group consisting of: a visual effect, an auditory effect and a tactile effect.

10. The method as defined in claim 1, wherein said step of transmitting the non-language message onto the mobile telecommunications network in a signal intended for said second user involves incorporating the non-language message in an electronic message conveyed by electronic messaging infrastructure in the mobile telecommunications network.

11. The method as defined in claim 10, wherein said electronic message conveyed by electronic messaging infrastructure in the mobile telecommunications network is selected from the group consisting of: Short Message Services (SMS), Multimedia Message Services (MMS) and email.

12. A method of performing non-language messaging in a mobile telecommunications network for mobile communication terminals, the method involving:
receiving, in a second mobile communication terminal having a second user, a signal originating from a first user of a first mobile communication terminal;
deriving from said signal a non-language message intended for said second user; and
performing the non-language message in a user interface of the second terminal;
wherein no manual intervention is required from said second user in said steps of receiving, deriving and performing.

13. The method as defined in claim 12, wherein said step of performing the non-language message involves generating a direct effect in the user interface of the second terminal, said direct effect including at least one effect selected from the group consisting of: a visual effect, an auditory effect and a tactile effect.

14. The method as defined in claim 12, wherein said steps of receiving a signal and deriving a non-language message involve receiving an electronic message conveyed by electronic messaging infrastructure in the mobile telecommunications network, and obtaining said non-language message from a payload of said electronic message.

15. The method as defined in claim 14, wherein said electronic message conveyed by electronic messaging infrastructure in the mobile telecommunications network is selected from the group consisting of: Short Message Services (SMS), Multimedia Message Services (MMS) and email.

16. The method as defined in claim 13, further comprising the steps of
receiving an additional signal;
deriving from said additional signal an additional non-language message intended for said second user; and
if said additional non-language message fulfills a prerequisite, generating an enhanced version of said direct effect in the user interface of the second terminal.

17. The method as defined in claim 16, wherein said prerequisite is at least one of the following:
that said additional signal originates from said first user;
that said signal and said additional signal are received within a certain time period;
that said non-language message and said additional non-language message are of a same type or of associated types.

18. The method as defined in claim 13, wherein the direct effect generated in the user interface of the second terminal is temporary and ends after a certain time.

19. The method as defined in claim 18, wherein the direct effect generated in the user interface of the second terminal is degraded before it ends after said certain time.

20. The method as defined in claim 12, involving the further step, upon performing said non-language message, of:
providing an offer in the user interface of the second terminal for said second user to establish communication with said first user over said mobile telecommunications network.

21. The method as defined in claim 20, wherein, after acceptance of said offer has been given by said second user, communication is established with said first user by one of the following communication channels: an electronic message, a non-language message, a voice call or a video call.

22. The method as defined in claim 1, wherein said step of detecting a first user's actuation of an input device involves detecting depression of a first key followed by depression of a second key among a plurality of keys.

23. The method as defined in claim 22, wherein said first key is an alphanumeric key and said second key is a dedicated key for non-language messaging.

24. A mobile communication terminal having a wireless interface to a mobile telecommunications network and a user interface capable of performing the steps of the method defined in claim 1.

25. A mobile communication terminal having a wireless interface to a mobile telecommunications network and a user interface capable of performing the steps of the method defined in claim 12.

26. A mobile telecommunications system suited for a first user of a first mobile communication terminal and a second user of a second mobile communication terminal, the mobile telecommunications system comprising electronic messaging infrastructure capable of conveying a non-language message, generated in response to an actuation by said first user of an input device included in said first terminal, from said first terminal to said second terminal, such that said non-language message is automatically received and performed in a user interface of the second terminal without manual intervention by said second user.
